(19) United States
(12) Patent Application Publication
(10) Pub. No.: US 2016/0131080 A1
(43) Pub. Date: May 12, 2016

(54) PROPULSION UNIT FOR AN AIRCRAFT

(71) Applicant: AIRCELLE, Gonfreville L'orcher (FR)

(72) Inventors: Corentin HUE, Le Havre (FR); Thibault Delesalle, Saint-Roman-De-Colbosc (FR)

(73) Assignee: AIRCELLE, Gonfreville L'orcher (FR)

(21) Appl. No.: 14/939,946

(22) Filed: Nov. 12, 2015

Related U.S. Application Data
(63) Continuation of application No. PCT/FR2014/051120, filed on May 14, 2014.

(30) Foreign Application Priority Data
May 14, 2013 (FR) 1354306

(51) Int. Cl. F02K 1/76

(52) U.S. Cl. CPC F02K 1/763; F05D 2270/62

(57) ABSTRACT

An aircraft propulsion assembly including a turbojet nacelle, and the nacelle includes a stationary structure and a movable structure. The movable structure includes: a thrust reversal device including a cowl translatable along a substantially longitudinal axis of the nacelle between a retracted position, and a deployed position; and a secondary air flow exhaust nozzle including a device for electrically controlling and actuating the nozzle. In particular, the device for controlling and actuating the nozzle includes an electrical switch suitable for being closed during a direct jet operation of the nacelle and moreover suitable for being open during a reverse jet operation. The electrical switch includes a stationary connector and a movable connector.

### CROSS-REFERENCE TO RELATED APPLICATIONS

This application is a continuation of International Application No. PCT/FR 2014/051120, filed on May 14, 2014, which claims the benefit of FR13/54306, filed on May 14, 2013. The disclosures of the above applications are incorporated herein by reference.

### FIELD

The present disclosure relates to a propulsion unit for an aircraft.

### BACKGROUND

The statements in this section merely provide background information related to the present disclosure and may not constitute prior art.

An aircraft is moved by several turbojet engines, each housed in a nacelle. A nacelle presents generally a tubular structure along a longitudinal axis comprising a fixed upstream section constituted by an air inlet upstream of the turbojet engine, a fixed mid-section intended to surround a fan of the turbojet engine, a downstream section accommodating thrust reversal means and intended to surround the combustion chamber of the turbojet engine, the upstream and the downstream of the nacelle being defined with reference to the flow direction of the airflow in the nacelle during a direct jet operation, the upstream of the nacelle corresponding to a portion of the nacelle through which the airflow penetrates, and the downstream corresponding to an ejection area of said airflow.

Modern nacelles are intended to accommodate a bypass turbojet engine capable of generating, by means of the blades of the rotating fan, a hot airflow (also called <<primary flow>>) coming from the combustion chamber of the turbojet engine, and a cold airflow (<<secondary flow>>) which circulates outside of the turbojet engine through an annular passage, also called <<annular flow path>>). Both airflows are ejected from the turbojet engine via the rear of the nacelle.

The annular flow path is formed by an outer structure, called Outer Fixed Structure (OFS) and a concentric inner structure, called Inner Fixed Structure (IFS), surrounding the structure of the engine itself downstream of the fan. The inner and outer structures belong to the downstream section.

The role of a thrust reverser during landing of an aircraft is to improve the braking ability of the latter by redirecting forward at least part of the thrust generated by the turbojet engine. In this phase, the thrust reverser obstructs the cold flow path and directs the latter forward of the nacelle, thereby generating a counter-thrust which adds to the braking of the wheels of the aircraft.

The means implemented to achieve this redirection of the cold flow vary depending on the type of the thrust reverser. The structure of a thrust reverser comprises one or several movable cowl(s) displaceable between, on the one hand, a deployed position in which they open a passage within the nacelle intended for the diverted flow, and on the other hand, a retracted position in which they close this passage. These cowls may fulfill a function of deflection or simply activation of other diverting means.

In the case of a cascade-type thrust reverser, the redirection of the airflow is achieved by cascade vanes, the thrust reverser cowl(s) having only but a simple function of sliding substantially along the longitudinal axis of the nacelle and aiming to uncover or cover these cascades. Complementary blocking doors, also called flaps, activated by the sliding of the cowling, generally allow closing the flow path downstream of the cascades in order to optimize the redirection of the cold flow.

The sliding of the cowling is achieved thanks to a control and actuation device of thrust reverser comprising a plurality of actuators connected to the movable cowl(s) of the thrust reverser. These actuators may be constituted by cylinders which are hydraulically, pneumatically or still electrically actuated, so as to lighten the nacelle and simplify its operation, in particular at the required maintenance cycles and the management of the hydraulic or pneumatic fluids.

The electrical actuation systems improves the management of energy depending on the power actually required for the operation of these systems while occupying less space in the nacelle and not requiring any pressurized fluid circulation circuit. The electrical actuators are constituted by cylinders typically set in motion by means of one or several electric motor(s) mounted on the fixed structure of the nacelle, or on the casing surrounding the fan of the turbojet engine.

Moreover, the tubular structure of the nacelle is generally terminated by a fixed or variable-section ejection nozzle (<<Variable Fan Nozzle>>) which will be called <<variable nozzle>> in the following description.

In one known form, the variable nozzle is formed by movable elements comprising typically one or several sliding cowl(s) mounted downstream of the thrust reverser cowl(s) and configured so as to allow a variation of the ejection section of the secondary airflow at the outlet of the annular flow path and in order to improve the performance of the turbojet engine depending on the flight phases.

This nozzle may be associated to a control and actuation system which is independent from that of the thrust reverser, comprising a plurality of actuators constituted by cylinders, for example electrical cylinders, actuated by means of one or several electric motor(s) mounted downstream of the movable cowl(s) of the thrust reverser.

In a thrust reversal situation, when the thrust reverser is fully deployed, the outlet section of the nozzle has almost no impact on the thrust generated by the turbojet engine, the secondary airflow achieving the most significant part of the thrust of the turbojet engine being redirected by the thrust reverser upstream of the nacelle. Hence, the nozzle may indifferently be in a fully retracted or a fully deployed position, or still in an intermediate position between these two extreme positions.

Nonetheless, an unexpected displacement of the cowl(s) of the nozzle may be detrimental when the nacelle is in reverse jet operation.

Indeed, the actuation device of the thrust reverser can be supplied by the electrical network of the aircraft when the nacelle is in reverse jet operation. This network may not be adapted for simultaneously supplying the actuation devices of the thrust reverser and the variable nozzle. An unexpected actuation of the cowl(s) of the variable nozzle may result in a dysfunction of the electrical network of the aircraft, which may result in a dysfunction of the thrust reverser.

In order to overcome such a drawback, there is known from the prior art a solution consisting of providing for redundant systems that block the displacement of the nozzle when the thrust reverser is being deployed or when it is deployed. Nonetheless, these redundant locking systems increase the weight of the nacelle.

### SUMMARY

The present disclosure provides a propulsion unit for an aircraft, comprising a nacelle for a turbojet engine, said nacelle comprising a fixed structure and a movable structure downstream of said fixed structure, said movable structure comprising:
a thrust reverser device comprising at least one cowl movable in translation along a substantially longitudinal axis of the nacelle between a retracted position corresponding to a direct jet operation of the nacelle and a deployed position corresponding to a reverse jet operation of the nacelle,
a nozzle for ejecting a secondary airflow, downstream of said thrust reverser device, comprising an electrical control and actuation device of said nozzle,
said propulsion unit being remarkable in that the control and actuation device of the nozzle comprises at least one electrical switch adapted so as to be closed when the nacelle is in direct jet operation and to be open when the nacelle is in reverse jet operation, said electrical switch comprising at least one fixed connector secured to the fixed structure of the nacelle or to a fan casing of the turbojet engine, and at least one movable connector secured to the cowl of the thrust reverser device, said connectors being shaped so as to cooperate together when the nacelle is in direct jet operation and not to cooperate together when the nacelle is in reverse jet operation.

Thus, by providing for an electrical control and actuation device of the variable nozzle comprising an electrical switch adapted so as to be closed when the nacelle is in direct jet operation and to be open when the nacelle is in reverse jet operation, the actuation device of the variable nozzle is automatically deprived of power supply, thereby disconnecting the variable nozzle from the electrical network of the aircraft during the thrust reversal phase, and thus avoiding an unexpected displacement of the variable nozzle during the thrust reversal phase.

To this end, the electrical switch constitutes a simple means for disconnecting the actuation device of the nozzle when the nacelle is in reverse jet operation.

When the nacelle returns to its direct jet operation position, the switch automatically switches from its open position to its closed position, thereby enabling the power supply of the actuation device of the variable nozzle, and consequently, a variation of the outlet section of the nozzle.

In addition, by providing for an electrical switch comprising a set of fixed and movable connectors, a disturbance of the electrical network of the aircraft is avoided in that the transmission of the electric current is directly achieved by contact between the fixed and movable connectors.

Advantageously, the movable connector is mounted at the upstream end of said cowl of the thrust reverser device, and the fixed connector is mounted at the downstream end of the fixed structure of the nacelle or the fan casing of the turbojet engine, thereby allowing to connect directly together the fixed electrical connectors and the movable electrical connectors.

More specifically, the fixed connector comprises at least one fixed electrical contact and the movable connector comprises at least one movable electrical contact, and a longitudinal axis of said fixed electrical contact is substantially coincident with a longitudinal axis of said movable electrical contact at least when the switch is in a closed position.

In one form, at least one fixed, respectively movable, connector is shaped so as to support an axial, radial or angular misalignment of at least one movable, respectively fixed, connector.

This allows very advantageously to absorb the axial, radial and angular misalignments which are due to the deformations of the structure, in order to avoid damaging the electrical contacts and to provide the electrical continuity when the switch is closed.

The cowl of the thrust reverser device is set in motion thanks to a control and actuation device comprising a plurality of cylinders actuated by means of at least one electric motor controlled by an electronic management box of the thrust reverser device.

The control and actuation device of the variable nozzle comprises:
an electronic management box of the nozzle, connected to said electrical switch,
at least one cylinder actuated by means of at least one electric motor mounted on said cowl of the thrust reverser device, said motor being connected to said electrical switch.

More specifically, the electronic management box of the variable nozzle is connected to said at least one fixed connector of the electrical switch, and said at least one movable connector is connected to the electric motor of said cylinder, as well as to driving and monitoring elements of the control system of the variable nozzle.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates the propulsion unit according to the present disclosure, in direct jet operation, and the nozzle being in the retracted position;

FIG. 2 illustrates a first form of the electrical switch according to the present disclosure, in the closed position;

FIG. 3 illustrates the electrical switch according to a second form, in the open position;

FIG. 4 is a view similar to that of FIG. 1, the nozzle being displaced downstream of the nacelle; and

FIG. 5 illustrates the propulsion unit in the reverse jet operation, the nozzle being displaced downstream of the nacelle.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Referring to FIG. 1 which schematically represents a propulsion unit 1 according to the present disclosure.

The propulsion unit 1 comprises a nacelle 3 supporting a turbojet engine 5.

For more visibility, the fixed structure of the nacelle, which is constituted by the air inlet upstream section and the mid-section, has been removed. Thus, on the nacelle of FIG. 1, there is only represented the downstream section 7 of the nacelle 3, accommodating a thrust reverser device 9 and a variable nozzle 11 downstream of the thrust reverser device.

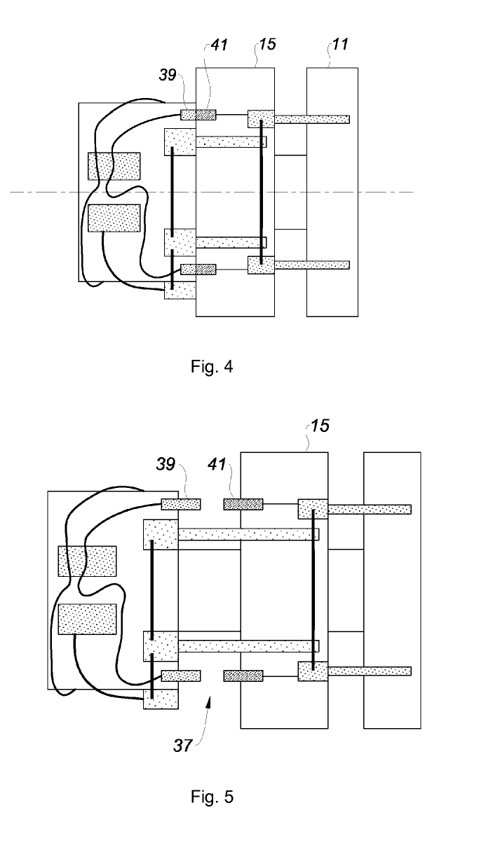

The turbojet engine comprises, in turn, a fan casing 13 accommodating a fan (not visible), the engine itself being visible in FIGS. 4 and 5.

The thrust reverser device 9 comprises one or several movable cowl(s) 15 displaceable along the longitudinal axis 17 of the nacelle, alternatively between a retracted position such as represented and a deployed position represented in FIG. 5.

To this end, the thrust reverser can be of the <<D-duct>> type, that is to say that the thrust reverser comprises two movable cowls, each cowl constituting a portion of the outer fixed structure of the nacelle and a portion of the inner fixed structure of the nacelle, the flow path of the secondary airflow being defined between said inner and outer structures.

The thrust reverser may also be of the <<O-duct>> type, that is to say constituted by an annular outer movable cowl extending on either side of a reactor mast from which the propulsion unit is hanging.

Regardless of the type of the thrust reverser, D-duct or O-duct, the movable cowl is set in motion thanks to a control and actuation device 19 of the thrust reverser.

Such a device may be a hydraulic, a pneumatic, or still an electrical device.

In the case of an electrical control and actuation device, such a device comprises an electronic management box 21 of the thrust reverser device, mounted, for example, on the fan casing 13 of the turbojet engine and connected, on the one hand, to the electrical network of the aircraft, and on the other hand, to an electric motor 23 of the thrust reverser device, by means of electrical cables 25.

The electric motor of the thrust reverser device itself is connected to actuators constituted by cylinders 27 connected to the movable cowl(s) 15 of the thrust reverser.

Setting the actuators in motion by the electric motor may be conventionally achieved by means of flexible shafts 29 well known in the prior art, allowing to transmit the motor torque to each cylinder.

Alternatively, each cylinder may be set in motion thanks to an electric motor which is dedicated thereto. In this case, the electronic management box of the thrust reverser device is connected to each electric motor (non represented variant).

The electric motor(s) are, for example, mounted on the fan casing 13, or still on a fixed frame supporting the thrust reverser device (non represented variant).

As a non-limiting example, the thrust reverser cowl is set in motion by means of four cylinders 27 distributed around the circumference of the nacelle.

The variable nozzle 11 comprises in turn one or several cowl(s) 31, movable in longitudinal translation thanks to a control and actuation device 33 of the nozzle.

In the context of the present disclosure, the control and actuation device of the nozzle is electrical. As is the case with the control and actuation device of the thrust reverser, the control and actuation device of the nozzle comprises an electronic management box 35 of the nozzle, connected to the electrical network of the aircraft.

According to the present disclosure, the device comprises one or several electrical switch(es) 37 each comprising a fixed connector 39 and a movable connector 41.

The fixed connector 39 is secured to the fan casing 13 of the turbojet engine or to the fixed structure of the nacelle, for example to the frame that supports the thrust reverser device (non represented variant).

The fixed connector 39 is mounted at the downstream end of the fan casing 13, or alternatively at the downstream end of the fixed structure of the nacelle, and is connected to the electronic management box 35 of the nozzle.

The movable connector 41 is in turn mounted on the movable cowl 15 of the thrust reverser device, for example at the upstream end of said cowl.

The movable connector 41 is itself connected by means of electrical cables 43 to actuators of the nozzle cowl(s), typically constituted by cylinders 45 connected to said cowl(s).

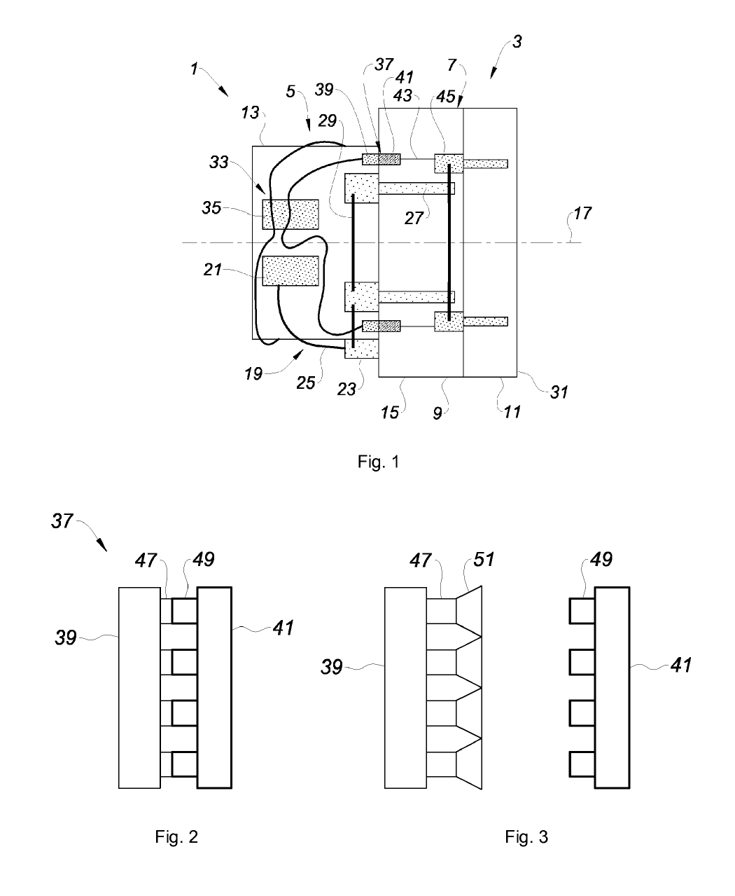

As represented in FIG. 2, the fixed 39 and movable 41 connectors are adapted so as to cooperate together when the thrust reverser movable cowl 15 is in its fully retracted position, that is to say when the nacelle is in direct jet operation.

As a non-limiting example, the control and actuation device 33 of the variable nozzle comprises an electrical switch 37 for each actuator of the movable cowl 31 of the nozzle.

Referring now to FIG. 2, which illustrates a first form of the electrical switch 37.

The fixed 39 and movable 41 connectors are both in the form of an electrical box each respectively enclosing a plurality of fixed 47 and movable 49 electrical contacts.

When the switch 37 is in the closed position, which position is represented in FIG. 2, the fixed electrical contacts 47 cooperate with the movable electrical contacts 49, that is to say that the longitudinal axes of the fixed electrical contacts 47 are substantially coincident with those of the movable electrical contacts 49.

Means for centering and guiding the electrical contacts are generally provided between the fixed and movable connectors in order to provide a proper positioning between the fixed electrical contacts and the movable electrical contacts when the switch is in the closed position, that is to say when the nacelle is in direct jet operation.

According to a second form of the switch 37, represented in FIG. 3, the fixed connectors comprise means for absorbing the axial, radial and angular misalignments which are due to the deformations of the structure, in order to avoid damaging the electrical contacts and to provide the electrical continuity when the switch is closed.

To this end, the electrical box which encloses the fixed electrical contacts 47 presents a conical extreme portion 51, enabling an axial, angular and radial displacement of the movable connectors 41.

These conical ends allow for a proper centering of the movable connectors 41 with the fixed connectors 39, and consequently not damaging the electrical contacts during connection or disconnection. This further allows eliminating the need for specific centering and guiding means between the electrical contacts, thereby allowing reducing advantageously the total weight compared to the preceding form.

Of course, said means for absorbing the axial, radial and angular deviations may alternatively be mounted on the movable electrical connectors or may consist of complementary devices mounted on each portion of the connector.

The operation of the propulsion unit according to the present disclosure will now be described.

When the nacelle is in situation of direct jet operation, represented in FIGS. 1 and 4, the thrust reverser cowl 15 is in the retracted position.

The switch 37 is in the closed position and thus, the electrical connectors of the switch 37 cooperate together, thereby enabling the power supply of the control and actuation device 33 of the nozzle 11.

In FIG. 1, the nozzle 11 is in the retracted position, and its outlet section can be modified in order to optimize the motor performances of the propulsion unit, when the aircraft is in flight phase (take-off, landing or cruise).

As represented in FIG. 4, the control and actuation device of the nozzle has been activated, and the nozzle has been displaced downstream of the nacelle in order to reduce the outlet section of the secondary airflow.

When it is desired to switch into the reverse jet operation, the electronic box of the control and actuation device of the thrust reverser controls the displacement of the movable cowl(s) 15 of the thrust reverser from their retracted position, represented in FIGS. 1 and 4, toward their deployed position, represented in FIG. 5.

The electrical switch 37 then automatically switches from its closed position to its open position, which corresponds to a disconnection between the fixed electrical connectors 39 and the movable electrical connectors 41, which do no longer cooperate together.

Indeed, the moment a translation of the movable cowl(s) of the thrust reverser occurs, the electrical switch is in the open position, thereby preventing the power supply of the control and actuation device 33 of the nozzle. In such a situation, the electronic management box 35 of the nozzle 11 has no longer any effect on the cylinders 27 of the nozzle.

When the nacelle switches again to the direct jet operation, the fixed 39 and movable 41 connectors automatically connect again, and the electrical switch 37 switches from its open position to its closed position.

It should be noted that if it is desired to have the nozzle in the retracted position when the nacelle is in the reverse jet operation, the nozzle cowl(s) are displaced from their downstream position toward their upstream position before controlling the translational displacement of the thrust reverser cowl(s) from their retracted position toward their deployed position.

Thanks to the present disclosure, by providing for an electrical control and actuation device of the variable nozzle comprising an electrical switch adapted to be closed when the nacelle is in the direct jet operation and open when the nacelle is in the reverse jet operation, the actuation device of the variable nozzle is automatically deprived of power supply the moment the cowl of the thrust reverser device is not in its retracted position, thereby allowing to disconnect the variable nozzle from the electrical network of the aircraft during the thrust reversal phase, and thus to avoid an inadvertent displacement of the variable nozzle during the thrust reversal phase.

Advantageously, this allows avoiding any dysfunction of the electrical network of the aircraft, which is not adapted for sustaining simultaneously an operation on the thrust reverser device and on the variable nozzle, which would result in a dysfunction of the thrust reverser device.

Furthermore, the electrical switch constitutes a simple means for disconnecting the actuation device of the nozzle when the nacelle is in the reverse jet operation. When the nacelle returns to its direct jet operation position, the switch switches automatically from its open position to its closed position, thereby enabling the power supply of the actuation device of the variable nozzle, and consequently, a variation of the outlet section of the nozzle.

Finally, it goes without saying that the present disclosure is not limited to the sole forms of this propulsion unit, described above only but as illustrative examples, but it encompasses on the contrary all variants involving the technical equivalents of the described means as well as their combinations if these are within the scope of the present disclosure.

What is claimed is:

1. A propulsion unit for an aircraft comprising a nacelle for a turbojet engine, the nacelle comprising a fixed structure and a movable structure downstream of the fixed structure, the movable structure comprising:
a thrust reverser device comprising at least one cowl movable in translation along a substantially longitudinal axis of the nacelle between a retracted position corresponding to a direct jet operation of the nacelle and a deployed position corresponding to a reverse jet operation of the nacelle; and
a nozzle for ejecting a secondary airflow and disposed downstream of the thrust reverser device, the nozzle comprising an electrical control and actuation device,
wherein the electrical control and actuation device of the nozzle comprises at least one electrical switch configured to be closed when the nacelle is in the direct jet operation and to be open when the nacelle is in the reverse jet operation, and
wherein the at least one electrical switch comprises at least one fixed connector secured to the fixed structure of the nacelle or to a fan casing of the turbojet engine, and at least one movable connector secured to the at least one cowl of the thrust reverser device, the fixed and movable connectors being shaped so as to cooperate with each other when the nacelle is in the direct jet operation and not to cooperate with each other when the nacelle is in the reverse jet operation.

2. The propulsion unit according to claim 1, wherein the at least one movable connector is mounted at an upstream end of the at least one cowl of the thrust reverser device, and the at least one fixed connector is mounted at a downstream end of the fixed structure of the nacelle or the fan casing of the turbojet engine.

3. The propulsion unit according to claim 1, wherein the at least one fixed connector comprises at least one fixed electrical contact, the at least one movable connector comprises at least one movable electrical contact, and a longitudinal axis of the at least one fixed electrical contact is substantially coincident with a longitudinal axis of the at least one movable electrical contact when the at least one switch is in a closed position.

4. The propulsion unit according to claim 1, wherein the at least one fixed connector and the at least one movable connector are shaped so as to support an axial, radial or angular misalignment of the at least one movable connector and the at least one fixed connector, respectively.

5. The propulsion unit according to claim 1, wherein the at least one cowl of the thrust reverser device is set in a motion by a control and actuation device comprising a plurality of cylinders actuated by at least one electric motor controlled by an electronic management box of the thrust reverser device.

6. The propulsion unit according to claim 1, wherein the electrical control and actuation device of the nozzle comprises:
an electronic management box of the nozzle which is connected to the at least one electrical switch;
at least one cylinder actuated by at least one electric motor mounted on the at least one cowl of the thrust reverser device, the motor being connected to the at least one electrical switch.

7. The propulsion unit according to claim 6, wherein the electronic management box of the nozzle is connected to the at least one fixed connector of the at least one electrical switch, and the at least one movable connector is connected to the at least one electric motor of the at least one cylinder.
